(19) United States
(12) Patent Application Publication
(10) Pub. No.: US 2026/0052084 A1
(43) Pub. Date: Feb. 19, 2026

(54) DETERMINING COMPATIBILITY AND HUB SERVER FOR AUDIO STREAMING SESSIONS

(71) Applicant: Wenger Corporation, Owatonna, MN (US)

(72) Inventors: Jason Price, New Berlin, WI (US); Matthew Farstad, Stella, NC (US); Patrick Finn, Syracuse, NY (US)

(73) Assignee: Wenger Corporation, Owatonna, MN (US)

(21) Appl. No.: 19/294,724

(22) Filed: Aug. 8, 2025

Related U.S. Application Data
(60) Provisional application No. 63/683,829, filed on Aug. 16, 2024.

(51) Int. Cl. H04L 43/0852; H04L 43/10

(52) U.S. Cl. CPC H04L 43/0852; H04L 43/10

(57) ABSTRACT

A system includes a web application server, a plurality of hub servers, and a first audio streaming device. The first audio streaming device is configured to ping each hub server of the plurality of hub servers to determine a respective latency between the first audio streaming device and each hub server to provide a first plurality of latencies. The first audio streaming device is configured to transmit the first plurality of latencies to the web application server. The web application server is configured to store the first plurality of latencies in a latency table comprising a respective second plurality of latencies for a second audio streaming device. The web application server is configured to determine a compatibility for audio streaming between the first audio streaming device and the second audio streaming device based on the latency table.

### CROSS-REFERENCE TO RELATED APPLICATIONS

This application claims the benefit of U.S. Provisional Patent Application No. 63/683,829, filed Aug. 16, 2024.

### BACKGROUND

Internet latency between users of an online networking/collaboration platform may lead to a noticeable delay in data packets containing audio, such as music. The internet latency may make it nearly impossible for multiple (e.g., two or more) people to collaborate in real time over a network and keep time with each other while playing live music.

For these and other reasons, there is a need for the present invention.

### SUMMARY

One example of the present disclosure relates to a system. The system includes a web application server, a plurality of hub servers, and a first audio streaming device. The first audio streaming device is configured to ping each hub server of the plurality of hub servers to determine a respective latency between the first audio streaming device and each hub server to provide a first plurality of latencies. The first audio streaming device is configured to transmit the first plurality of latencies to the web application server. The web application server is configured to store the first plurality of latencies in a latency table comprising a respective second plurality of latencies for a second audio streaming device. The web application server is configured to determine a compatibility for audio streaming between the first audio streaming device and the second audio streaming device based on the latency table.

Another example of the present disclosure relates to a system. The system includes a plurality of audio streaming devices, a plurality of hub servers communicatively coupled to the plurality of audio streaming devices, and a web application server storing a latency table comprising a latency between each audio streaming device of the plurality of audio streaming devices and each hub server of the plurality of hub servers. The web application server is configured to receive a request to initiate an audio streaming session between at least two selected audio streaming devices of the plurality of audio streaming devices and select a hub server of the plurality of hub servers to host the audio streaming session based on the latency table.

Yet another example of the present disclosure relates to an audio streaming device. The audio streaming device includes a first analog audio input port, an audio output port, a network interface, a memory storing instructions, and a processor communicatively coupled to the analog audio input port, the audio output port, the network interface, and the memory. The processor is configured to execute the instructions to ping each hub server of a plurality of hub servers to determine a respective latency between the audio streaming device and each hub server to provide a plurality of latencies and transmit the plurality of latencies to a web application server.

Yet another example of the present disclosure relates to a method. The method includes receiving, at a web application server, from each audio streaming device of a plurality of audio streaming devices, a latency between each audio streaming device and each hub server of a plurality of hub servers. The method includes storing, in the web application server, a latency table comprising the latency between each audio streaming device and each hub server. The method includes determining, via the web application server, a compatibility for audio streaming between a first audio streaming device and a second audio streaming device of the plurality of audio streaming devices based on the latency table.

### BRIEF DESCRIPTION OF THE DRAWINGS

FIG. 1 is a block diagram illustrating an example system for streaming audio between devices.

FIG. 2 is a block diagram illustrating an example audio streaming device.

FIG. 3 is a block diagram illustrating an example processing system for the audio streaming device of FIG. 2.

FIGS. 4A and 4B are block diagrams illustrating example processing systems for the web application server of FIG. 1.

FIG. 5A is an example latency table for storing latencies for a plurality of audio streaming devices.

FIG. 5B is an example location table for storing location data for a plurality of audio streaming devices.

FIG. 5C is an example session table for storing audio streaming session data for a plurality of audio streaming devices.

FIG. 6 is a diagram illustrating example physical and internet routing distances between users of the system of FIG. 1.

FIG. 7 is a flow diagram illustrating an example method for determining compatibility for audio streaming between a first audio streaming device and a second audio streaming device.

FIG. 8 is a flow diagram illustrating another example method for determining compatibility for audio streaming between a first audio streaming device and a second audio streaming device.

FIG. 9 is a diagram illustrating an example system including distances between users and hub servers.

FIG. 10 is a table illustrating example latencies between users and hub servers for determining compatibility between users for audio streaming.

FIGS. 11A and 11B are diagrams illustrating example systems for determining a compatibility for audio streaming between a first user and a second user.

FIG. 12 is a flow diagram illustrating another example method for determining compatibility for audio streaming between a first audio streaming device and a second audio streaming device.

FIGS. 13A-13C are flow diagrams illustrating an example method for selecting a hub server to host an audio streaming session.

FIG. 14 is a table illustrating example latencies between users and hub servers for selecting a hub server to host an audio streaming session.

FIG. 15 is a flow diagram illustrating another example method for selecting a hub server to host an audio streaming session.

FIG. 16 is a table illustrating example latencies between users and hub servers for selecting a hub server to host an audio streaming session.

FIG. 17 is a flow diagram illustrating an example method for updating a session table.

FIG. 18 is a flow diagram illustrating another example method for determining compatibility for audio streaming between a first audio streaming device and a second audio streaming device.

### DETAILED DESCRIPTION

In the following Detailed Description, reference is made to the accompanying drawings, which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

It is to be understood that the features of the various examples described herein may be combined with each other, unless specifically noted otherwise.

Disclosed herein are systems and devices including processing systems which locally receive analog audio input and/or digital audio input and combine the digital audio input and/or analog audio input with digital audio received over a network, such as the internet. The processing systems present the combined audio to the user, such as via a speaker or headphones. Internet latency between users of an online musician networking/collaboration platform may affect the quality of the user experience for playing live music over the internet. Due to the nature of internet routing, the underlying infrastructure, and the variability within end-user network configurations, determining the user experience for playing live music over the internet based on geo-location may not be accurate. Due to the internet infrastructure and the laws of physics that dictate how fast data can traverse back and fourth between users at varying distances, the user experience may vary widely between users who are located at similar physical distances from one another.

Accordingly, disclosed herein are systems, devices, and methods to determine compatibility for audio streaming between audio streaming devices corresponding to users and selecting a hub server to host an audio streaming session between users.

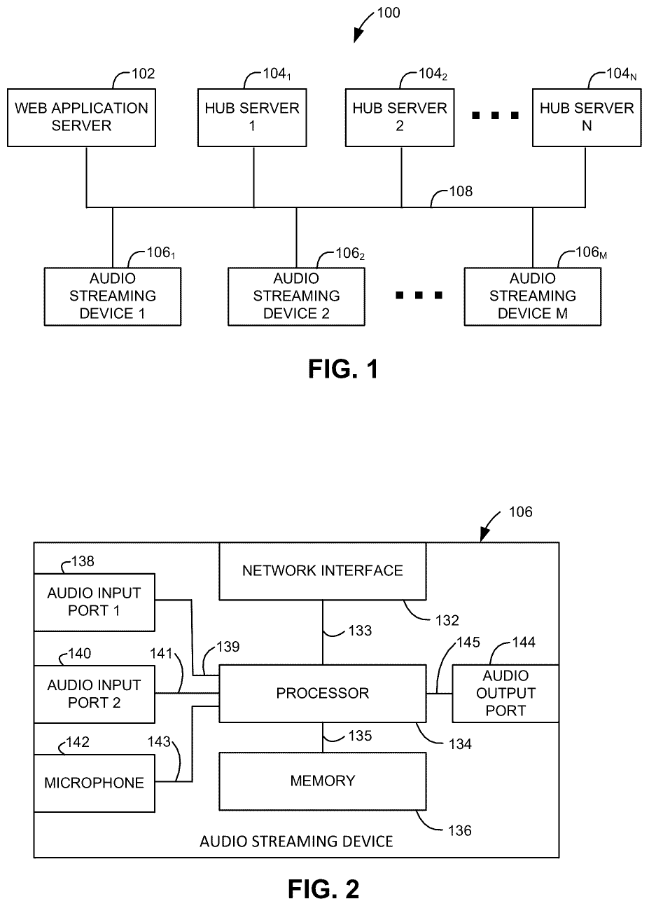

FIG. 1 is a block diagram illustrating an example system 100 for streaming audio between audio streaming devices corresponding to users. System 100 includes a web application server 102 and a plurality of hub servers 104₁ to 104_{N}, where “N” is any suitable number of hub servers (e.g., 5, 10, 15, 20, 30, 50, etc.). System 100 also includes a plurality of audio streaming devices 106₁ to 106_{M}, where “M” is any suitable number of audio streaming devices (e.g., 50, 100, 500, 1000, 5000, 10,000, etc.). The web application server 102, the plurality of hub servers 104₁ to 104_{N}, and the plurality of audio streaming devices 106₁ to 106_{M} are communicatively coupled to each other via a network 108 (e.g., local area network, wide area network, and/or internet, etc.).

The web application server 102 hosts a web application for an online musician networking/collaboration platform. Users, each corresponding to an audio streaming device 106₁ to 106_{M}, may access the web application to play music in real time with other users of the musician networking/collaboration platform. Each hub server 104₁ to 104_{N} may host an audio streaming session between at least two audio streaming devices 106₁ to 106_{M}. Each hub server 104₁ to 104_{N} may be physically located in a different region of the world. For example, for North America, a first hub server 104₁ may be located in a North Central region, a second hub server 104₂ may be located in a US Central region, a third hub server 104₃ may be located in a Canada Central region, a fourth hub server 104₄ may be located in an East US region, a fifth hub server 104₅ may be located in a West Central US region, a sixth hub server 104₆ may be located in a Canada East region, a seventh hub server 104₇ may be located in a South Central US region, etc. In some examples, hub servers 104₁ to 104_{N} may be distributed such that at least one hub server 104₁ to 104_{N} is close enough to each user to enable each user to have an acceptable user experience when playing music in real time with other users of the musician networking/collaboration platform.

In some examples, an audio streaming session may be a peer-to-peer session that does not utilize a hub server 104₁ to 104_{N}. For example, a streaming session including less than or equal to a threshold number of audio streaming devices 106₁ to 106_{M} (e.g., 2, 3, 4, 5) may be implemented as a peer-to-peer session, while a streaming session including more than the threshold number of audio streaming devices may be hosted by a hub server 104₁ to 104_{N}. In some examples, the available bandwidth of each audio streaming device 106₁ to 106_{M} participating in an audio streaming session might be calculated and if the cumulative bandwidth (minus a buffer, such as 10% to 20%) to sustain a peer-to-peer session exceeds the available bandwidth of any single audio streaming device participating in the audio streaming session, the session might be switched from a peer-to-peer session to a hub server hosted session.

The web application server 102 is configured to communicate with each audio streaming device 106₁ to 106_{N} to determine compatibility for audio streaming between one audio streaming device 106₁ to 106_{M} and another audio streaming device 106₁ to 106_{N} as further described below with reference to FIGS. 2-18. In some examples, the web application server 102 determines the compatibility based on latencies between each audio streaming device 106₁ to 106_{N} and each hub server 104₁ to 104_{N}. In some examples, the web application server 102 determines the compatibility based on latencies between each audio streaming device 106₁ to 106_{N} and each hub server 104₁ to 104_{N} and the physical location (e.g., geographic coordinates) of each audio streaming device 106₁ to 106_{M}. The web application server 102 is also configured to select a hub server 104₁ to 104_{N} to host an audio streaming session between at least two audio streaming devices 106₁ to 106_{N} as described below with reference to FIGS. 2-18. In some examples, the web application server 102 selects a hub server to host an audio streaming session based on latencies between each audio streaming device 106₁ to 106_{M} and each hub server 104₁ to 104_{N}. In some examples, the web application server 102 selects a hub server to host an audio streaming session based on latencies between each audio streaming device 106₁ to 106_{M} and each hub server 104₁ to 104_{N} and the physical location (e.g., geographic coordinates) of each audio streaming device 106₁ to 106_{M}.

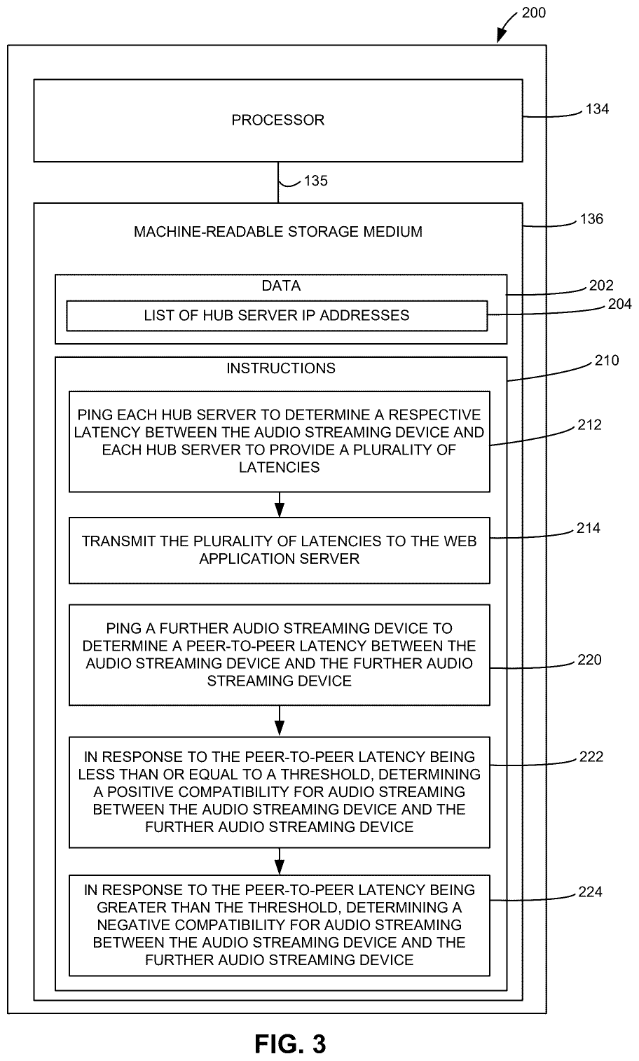

FIG. 2 is a block diagram illustrating an example audio streaming device 106. In some examples, audio streaming device 106 may provide each audio streaming device 106₁ to 106_{M} of FIG. 1. Audio streaming device 106 may include a network interface 132, a processor 134, a memory 136, a first audio input port 138 (e.g., audio input port 1), a second audio input port 140 (e.g., audio input port 2), a microphone 142, and an audio output port 144. The processor 134 is communicatively coupled to the network interface 132 through a communication path 133 and to the memory 136 through a communication path 135. The processor 134 is communicatively coupled to the first audio input port 138 through a communication path 139, to the second audio input port 140 through a communication path 141, to the microphone 142 through a communication path 143, and to audio output port 144 through a communication path 145. Network interface 132 is configured to connect the audio streaming device 106 to a network (e.g., Local Area Network, Wide Area Network, internet). In some examples, network interface 132 may be connected to the network via a cable, such as an Ethernet cable. The processor 134 and memory 136 may provide a processing system for controlling the operation of the audio streaming device 106 as will be described below with reference to FIG. 3.

In some examples, the first audio input port 138 and the second audio input port 140 are analog audio input ports each configured to receive an analog audio stream from a device (e.g., musical instrument, microphone, etc.) plugged into the respective audio input port. The analog audio streams might be converted into a combined digital audio stream by the processor 134 and transmitted over the network connected to the network interface 132 to a selected hub server 104₁ to 104_{N} hosting an audio streaming session for the audio streaming device 106. Microphone 142, which may be an analog or digital microphone, is configured to provide another audio stream, which may be combined with the audio streams from the first audio input port 138 and the second audio input port 140 and transmitted over the network connected to the network interface 132 to the selected hub server 104₁ to 104_{N}.

In some examples, the audio output port 144 is an analog audio output port configured to output an analog audio stream to speakers (e.g., headphones) plugged into the audio output port 144. The processor 134 might receive a digital audio stream via the network connected to network interface 132 from the selected hub server 104₁ to 104_{N} (where the selected hub server 104₁ to 104_{N} received the digital audio stream from one or more other audio streaming devices participating in the audio streaming session), combine the digital audio stream with the audio stream from audio input ports 138 and 140 and/or from microphone 142, and output the combined audio stream to the audio output port 144. Accordingly, multiple users of the online musician networking/collaboration platform, each including an audio streaming device 106, may play live music with each other over the internet via an audio streaming session hosted by a selected hub server 104₁ to 104_{N}, which may be selected by web application server 102.

FIG. 3 is a block diagram illustrating an example processing system 200 for the audio streaming device 106 of FIG. 2. Processing system 200 includes the processor 134 and a machine-readable storage medium 136 (e.g., memory). Processor 134 is communicatively coupled to machine-readable storage medium 136 through the communication path 135. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 134 includes one (i.e., a single) central processing unit (CPU) or microprocessor or more than one (i.e., multiple) CPU or microprocessor, and/or other suitable hardware devices for accessing data 202 and for retrieval and execution of instructions 210 stored in machine-readable storage medium 136. Processor 134 may access a list of hub server IP addresses 204 and fetch, decode, and execute instructions 212-224 to operate an audio streaming device (e.g., 106). The list of hub server IP addresses 204 stores the IP addresses of each hub server 104₁ to 104_{N} of FIG. 1.

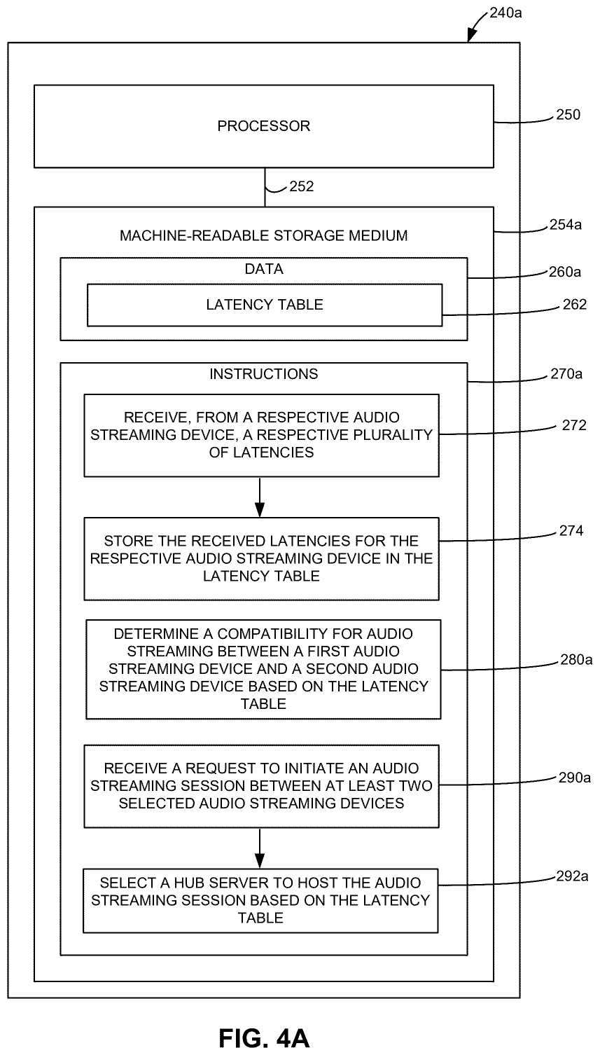

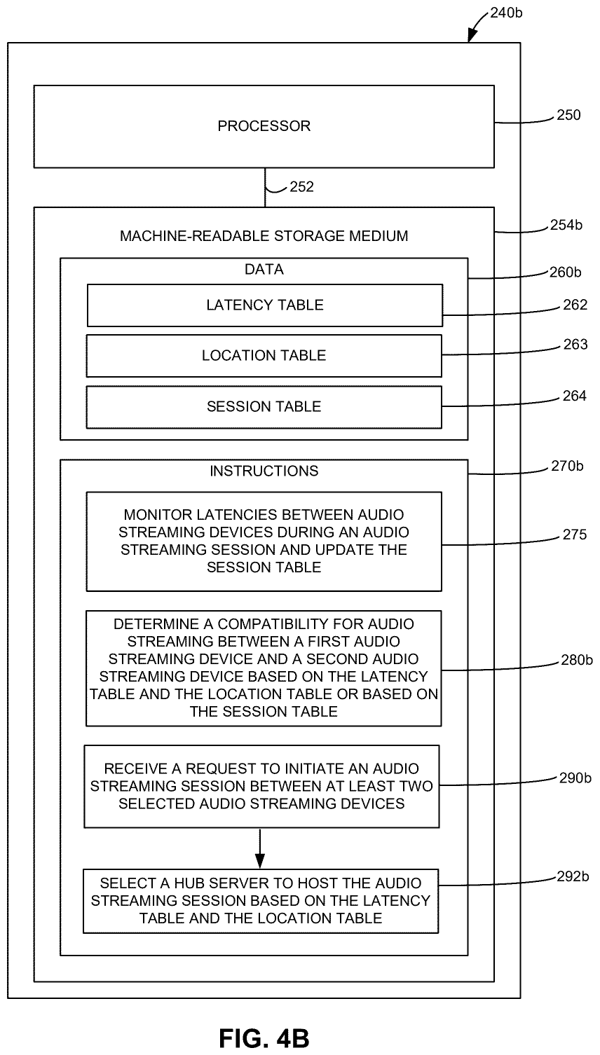

Processor 134 may fetch, decode, and execute instructions 212 to ping each hub server (e.g., 104₁ to 104_{N} of FIG. 1) to determine a respective latency between the audio streaming device (e.g., the respective 106₁ to 106_{N}) and each hub server to provide a plurality of latencies. Processor 134 may fetch, decode, and execute instructions 214 to transmit the plurality of latencies to the web application server (e.g., 102 of FIG. 1). As further described below with reference to at least FIG. 4A, the web application server may then store the plurality of latencies in a latency table. In some examples, the processor 134 may fetch, decode, and execute other instructions (in place of instructions 214) to store the plurality of latencies in the latency table (e.g., cloud based latency table) without transmitting the plurality of latencies to the web application server.

In some examples, processor 134 may fetch, decode, and execute instructions 220 to ping a further audio streaming device (e.g., another one of 106₁ to 106_{N}) to determine a peer-to-peer latency between the audio streaming device (e.g., the respective 106₁ to 106_{N}) and the further audio streaming device. Processor 134 may fetch, decode, and execute instructions 222 to in response to the peer-to-peer latency being less than or equal to a threshold (e.g., 20 milliseconds, 30 milliseconds), determining a positive compatibility for audio streaming between the audio streaming device and the further audio streaming device. Processor 134 may fetch, decode, and execute instructions 224 to in response to the peer-to-peer latency being greater than the threshold, determining a negative compatibility for audio streaming between the audio streaming device and the further audio streaming device. A positive compatibility for audio streaming between the audio streaming devices indicates that users of the audio streaming devices may play live music with each other over the internet and have an acceptable user experience. A negative compatibility for audio streaming between the audio streaming devices indicates that users of the audio streaming devices may have an unacceptable user experience if they attempt to play live music with each other over the internet.

As an alternative or in addition to retrieving and executing instructions, processor 134 may include one (i.e., a single) electronic circuit or more than one (i.e., multiple) electronic circuits comprising a number of electronic components for performing the functionality of one of the instructions or more than one of the instructions in machine-readable storage medium 136. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 136 is a non-transitory storage medium and may be any suitable electronic, magnetic, optical, or other physical storage device that stores executable instructions. Thus, machine-readable storage medium 136 may be, for example, a random access memory (RAM), an electrically-erasable programmable read-only memory (EEPROM), a storage drive, an optical disc, and the like. Machine-readable storage medium 136 may be disposed within system 200, as illustrated in FIG. 3. In this case, the executable instructions may be installed on system 200.

Alternatively, machine-readable storage medium 136 may be a portable, external, or remote storage medium that allows system 200 to download the instructions from the portable/external/remote storage medium. In this case, the executable instructions may be part of an installation package.

FIG. 4A is a block diagram illustrating an example processing system 240a for the web application server 102 of FIG. 1. Processing system 240a includes a processor 250 and a machine-readable storage medium 254a (e.g., memory). Processor 250 is communicatively coupled to machine-readable storage medium 254a through a communication path 252. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

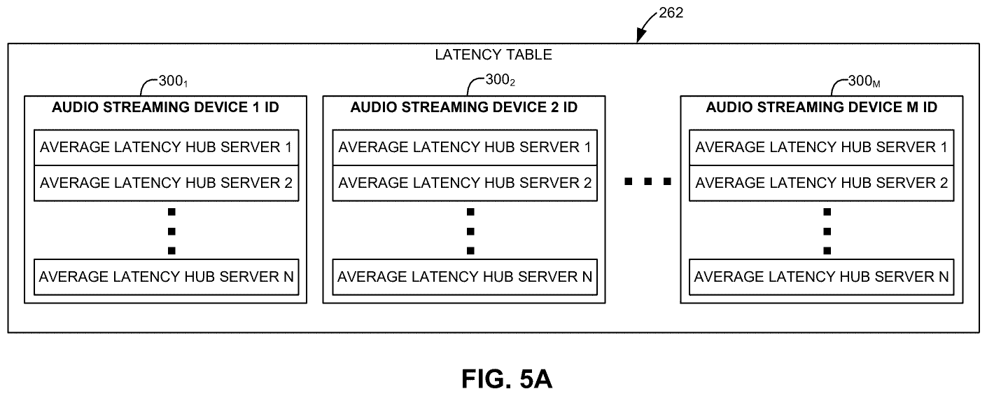

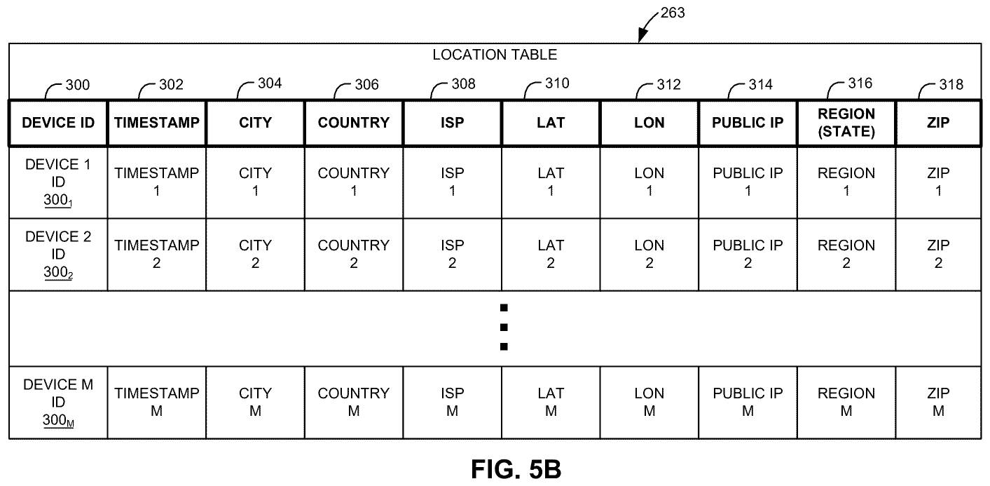

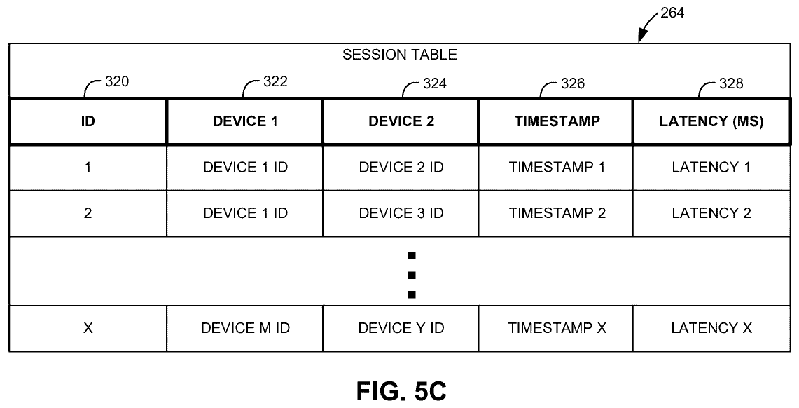

Processor 250 includes one (i.e., a single) central processing unit (CPU) or microprocessor or more than one (i.e., multiple) CPU or microprocessor, and/or other suitable hardware devices for accessing data 260a and for retrieval and execution of instructions 270a stored in machine-readable storage medium 254a. Processor 250 may access a latency table 262 and fetch, decode, and execute instructions 272-274 and 280a-292a to operate the web application server 102. The latency table 262 stores a list of latencies between each audio streaming device 106₁ to 106_{M} and each hub server 104₁ to 104_{N} of FIG. 1 as further described below with reference to FIG. 5A.

Processor 250 may fetch, decode, and execute instructions 272 to receive, from a respective audio streaming device (e.g., a respective 106₁ to 106_{M}), a respective plurality of latencies. Processor 250 may fetch, decode, and execute instructions 274 to store the received latencies for the respective audio streaming device in the latency table (e.g., 262).

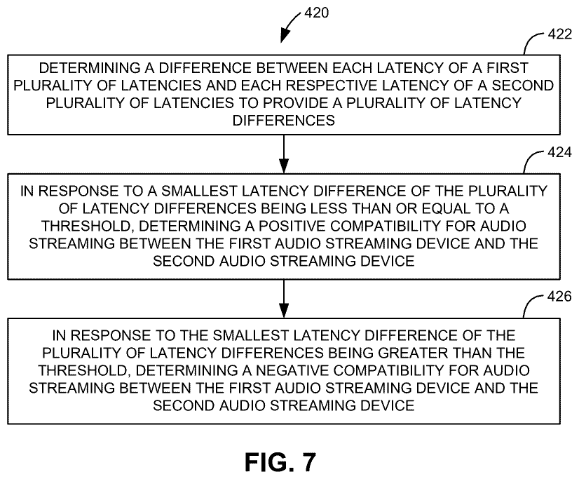

In some examples, processor 250 may fetch, decode, and execute instructions 280a to determine a compatibility for audio streaming between a first audio streaming device (e.g., one of 106₁ to 106_{M}) and a second audio streaming device (e.g., another one of 106₁ to 106_{M}) based on the latency table (e.g., 262). Determining a compatibility for audio streaming between a first audio streaming device and a second audio streaming device is further described below with reference to at least FIGS. 7-12.

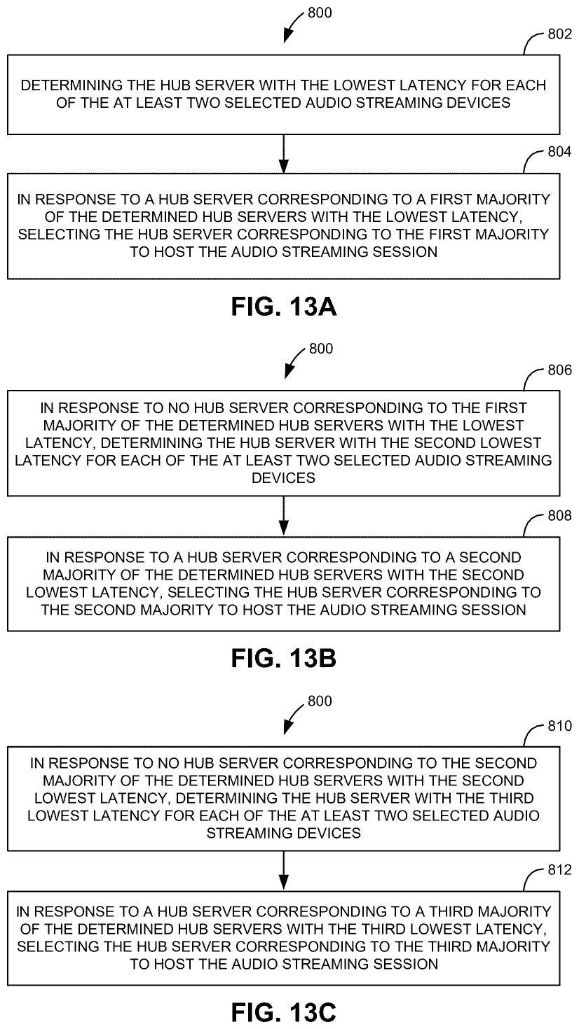

Processor 250 may fetch, decode, and execute instructions 290a to receive a request (e.g., from an audio streaming device 106₁ to 106_{N} or from a user through the web application) to initiate (or schedule) an audio streaming session between at least two selected audio streaming devices. Processor 250 may fetch, decode, and execute instructions 292a to select a hub server to host the audio streaming session based on the latency table (e.g., 262). Selecting a hub server to host the audio streaming session is further described below with reference to at least FIGS. 13A-16.

As an alternative or in addition to retrieving and executing instructions, processor 250 may include one (i.e., a single) electronic circuit or more than one (i.e., multiple) electronic circuits comprising a number of electronic components for performing the functionality of one of the instructions or more than one of the instructions in machine-readable storage medium 254a. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 254a is a non-transitory storage medium and may be any suitable electronic, magnetic, optical, or other physical storage device that stores executable instructions. Thus, machine-readable storage medium 254a may be, for example, a random access memory (RAM), an electrically-erasable programmable read-only memory (EEPROM), a storage drive, an optical disc, and the like. Machine-readable storage medium 254a may be disposed within system 240a, as illustrated in FIG. 4A. In this case, the executable instructions may be installed on system 240a. Alternatively, machine-readable storage medium 254a may be a portable, external, or remote storage medium that allows system 240a to download the instructions from the portable/external/remote storage medium. In this case, the executable instructions may be part of an installation package.

FIG. 4B is a block diagram illustrating another example processing system 240b for the web application server 102 of FIG. 1. Processing system 240b includes a processor 250 and a machine-readable storage medium 254b (e.g., memory). Processor 250 is communicatively coupled to machine-readable storage medium 254b through a communication path 252. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 250 includes one (i.e., a single) central processing unit (CPU) or microprocessor or more than one (i.e., multiple) CPU or microprocessor, and/or other suitable hardware devices for accessing data 260b and for retrieval and execution of instructions 270b stored in machine-readable storage medium 254b. Processor 250 may access a latency table 262, a location table 263, a session table 264, and fetch, decode, and execute instructions 275 and 280b-292b to operate the web application server 102. The location table 263 stores location data for each audio streaming device 106₁ to 106_{M} as further described below with reference to FIG. 5B. The session table 264 stores audio streaming session data for each audio streaming device 106₁ to 106_{M} as further described below with reference to FIG. 5C.

Processor 250 may fetch, decode, and execute instructions 275 to monitor latencies between audio streaming devices (e.g., 106₁ to 106_{M}) during an audio streaming session and update the session table (e.g., 264). In some examples, processor 250 may cache a running average of the latency between each pair of audio streaming devices during an audio streaming session and store the running average of the latency in the session table once the audio streaming session ends. In some examples, the running average of the latency may be displayed to the users during an audio streaming session, which provides an indication of the connection quality between the audio streaming devices.

In some examples, processor 250 may fetch, decode, and execute instructions 280b to determine a compatibility for audio streaming between a first audio streaming device (e.g., one of 106₁ to 106_{M}) and a second audio streaming device (e.g., another one of 106₁ to 106_{M}) based on the latency table (e.g., 262) and the location table (e.g., 263) or based on the session table (e.g., 264). In some examples to determine a compatibility for audio streaming between a first audio streaming device and a second audio streaming device, processor 250 may first check the session table to determine if a recent latency (e.g., within the past 30 to 90 days) has been stored for the first audio streaming device and the second audio streaming device pair. If a recent latency has been stored, processor 250 uses the stored latency to determine the compatibility for audio streaming between the first audio streaming device and the second audio streaming device. If a recent latency has not been stored in the session table, processor 250 may determine compatibility for audio streaming between the first audio streaming device and the second audio streaming device based on the latency table and the location table. Determining a compatibility for audio streaming between a first audio streaming device and a second audio streaming device is further described below with reference to at least FIGS. 7-12 and 18.

Processor 250 may fetch, decode, and execute instructions 290b to receive a request (e.g., from an audio streaming device 106₁ to 106_{M} or from a user through the web application) to initiate (or schedule) an audio streaming session between at least two selected audio streaming devices. Processor 250 may fetch, decode, and execute instructions 292b to select a hub server to host the audio streaming session based on the latency table (e.g., 262) and the location table (e.g., 263). Selecting a hub server to host the audio streaming session is further described below with reference to at least FIGS. 13A-16.

As an alternative or in addition to retrieving and executing instructions, processor 250 may include one (i.e., a single) electronic circuit or more than one (i.e., multiple) electronic circuits comprising a number of electronic components for performing the functionality of one of the instructions or more than one of the instructions in machine-readable storage medium 254b. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 254b is a non-transitory storage medium and may be any suitable electronic, magnetic, optical, or other physical storage device that stores executable instructions. Thus, machine-readable storage medium 254b may be, for example, a random access memory (RAM), an electrically-erasable programmable read-only memory (EEPROM), a storage drive, an optical disc, and the like. Machine-readable storage medium 254b may be disposed within system 240b, as illustrated in FIG. 4B. In this case, the executable instructions may be installed on system 240b. Alternatively, machine-readable storage medium 254b may be a portable, external, or remote storage medium that allows system 240b to download the instructions from the portable/external/remote storage medium. In this case, the executable instructions may be part of an installation package.

FIG. 5A is an example latency table 262 for storing latencies for a plurality of audio streaming devices (e.g., 106₁ to 106_{M}). Latency table 262 stores an audio streaming device ID 300₁ to 300_{M} corresponding to each audio streaming device 106₁ to 106_{M}, respectively. An average latency between the audio streaming device 106₁ to 106_{M} and each hub server (e.g., 104₁ to 104_{N}) is stored in association with the respective audio streaming device ID 300₁ to 300_{M}. In some examples, latency table 262 is written by the web application server 102 after an audio streaming device pings each hub server to determine the respective latency between the audio streaming device and each hub server and transmits the latencies to the web application server 102. In some examples, latency table 262 is written by an audio streaming device 106₁ to 106_{M} after the audio streaming device pings each hub server to determine the respective latency between the audio streaming device and each hub server.

FIG. 5B is an example location table 263 for storing location data for a plurality of audio streaming devices (e.g., 106₁ to 106_{M}). Location table 263 stores location data corresponding to each audio streaming device ID 300₁ to 300_{M}, stored in device ID 300, corresponding to each audio streaming device 106₁ to 106_{M}, respectively. The location data may include a timestamp 302, a city 304, a country 306, an internet service provider (ISP) 308, a latitude (LAT) 310, a longitude (LON) 312, a public internet protocol (IP) address 314, a region or state 316, and a zip code 318. In some examples, the location data may only include a subset of 302-318 or may include additional data. In some examples, location table 263 is written and/or updated by the web application server 102 in response to the audio streaming devices periodically (e.g., upon boot) transmitting device telemetry messages including their location data to the web application server 102.

FIG. 5C is an example session table 264 for storing audio streaming session data for a plurality of audio streaming devices (e.g., 106₁ to 106_{M}). Session table 264 stores audio streaming session data for each pair of audio streaming devices. Session table 264 may include a unique identifier (ID) 320 (e.g., primary key), a first device 322 of a device pair, a second device 324 of a device pair, a timestamp 326, and a latency 328 in milliseconds (ms) for the device pair. In some examples, each device pair may be stored lexicographically, such that when comparing the same two devices, each device may be stored in the same respective first device field 322 or second device field 324. The first device field 322 and the second device field 324 may store the corresponding audio streaming device IDs (e.g., 300₁ to 300_{M}) for the corresponding pair of audio streaming devices (e.g., 106₁ to 106_{M}). The latency field 328 may store the running average of the latency between the corresponding audio streaming devices during an audio streaming session. The timestamp field 326 may store the last day and time the corresponding latency field 328 was written and/or updated for the corresponding audio streaming devices. In some examples, session table 264 is written and/or updated by the web application server 102 in response to the termination of an audio session between audio streaming devices.

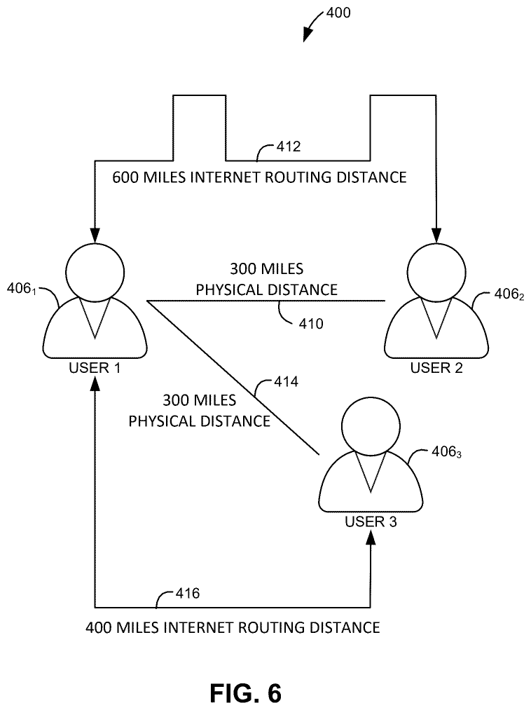

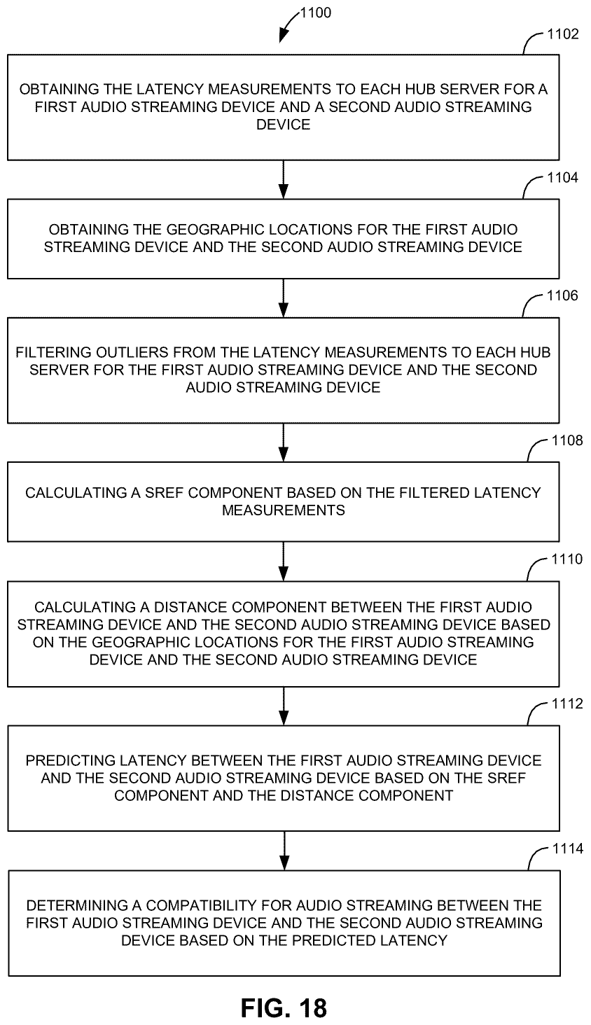

FIG. 6 is a diagram 400 illustrating example physical and internet routing distances between users (each corresponding to an audio streaming device 106₁ to 106_{M}) of the system 100 of FIG. 1. Users 406₁ to 406₃ may correspond to audio streaming devices 106₁ to 106₃, respectively. In this example, the first user 406₁ may be physically located 300 miles from the second user 406₂ as indicated at 410 and physically located 300 miles from the third user 406₃ as indicated at 414. In some examples, the physical distance (e.g., straight-line distance) between users 406₁ to 406₃ is determined based on location table 263 of FIG. 5B (e.g., using the haversine formula). The internet routing distance between the first user 406₁ and the second user 406₂, however, might be 600 miles as indicated at 412. The internet routing distance between the first user 406₁ and the third user 406₃ might be 400 miles as indicated at 416. Thus, due to the difference between the physical distance and the internet routing distance between users, determining the user experience for playing live music over the internet based on geo-location may not be accurate. Due to the underlying internet infrastructure and the laws of physics that dictate how fast data can traverse back and forth at varying distances, the user experience may vary widely between users who are located at similar physical distances from one another. Accordingly, in some examples as described below with reference to at least the following FIGS. 7-12, compatibility between users, which may be referred to as a Same Room Equivalence Factor (SREF), may be calculated based on the relationship between users who reside at various unknown locations and their relative internet latency to multiple remote hub servers (e.g., 104₁ to 104_{N}). In other examples as described below with reference to at least the following FIG. 18, compatibility between users may be based on the Same Room Equivalence Factor (SREF) between users and the geographic locations of the users who reside at various known locations (stored in location table 263).

FIG. 7 is a flow diagram illustrating an example method 420 for determining compatibility for audio streaming between a first audio streaming device (e.g., first user) and a second audio streaming device (e.g., second user). In some examples, method 420 may be implemented by further instructions stored in machine-readable storage medium 254a configured to be executed by processor 250 to determine a compatibility for streaming between a first audio streaming device and a second audio streaming device as indicated at 280a in FIG. 4A.

As illustrated in FIG. 7 at 422, method 420 includes determining a difference between each latency of a first plurality of latencies (e.g., latencies between a first audio streaming device and each hub server) and each respective latency of a second plurality of latencies (e.g., latencies between a second audio streaming device and each hub server) to provide a plurality of latency differences. For example, for a latency of 20 milliseconds between the first audio streaming device and a first hub server and a latency of 30 milliseconds between the second audio streaming device and the first hub server, the latency difference corresponding to the first hub server would equal 10 milliseconds. At 424, method 420 includes in response to a smallest latency difference of the plurality of latency differences (e.g., the smallest latency difference corresponding to one of the hub servers) being less than or equal to a threshold (e.g., 20 milliseconds, 30 milliseconds), determining a positive compatibility for audio streaming between the first audio streaming device and the second audio streaming device. At 426, method 420 includes in response to the smallest latency difference of the plurality of latency differences being greater than the threshold, determining a negative compatibility for audio streaming between the first audio streaming device and the second audio streaming device. As previously described, a positive compatibility for audio streaming between the first and second audio streaming devices indicates that users of the first and second audio streaming devices may play live music with each other over the internet and have an acceptable user experience. A negative compatibility for audio streaming between the first and second audio streaming devices indicates that users of the first and second audio streaming devices may have an unacceptable user experience if they attempt to play live music with each other over the internet.

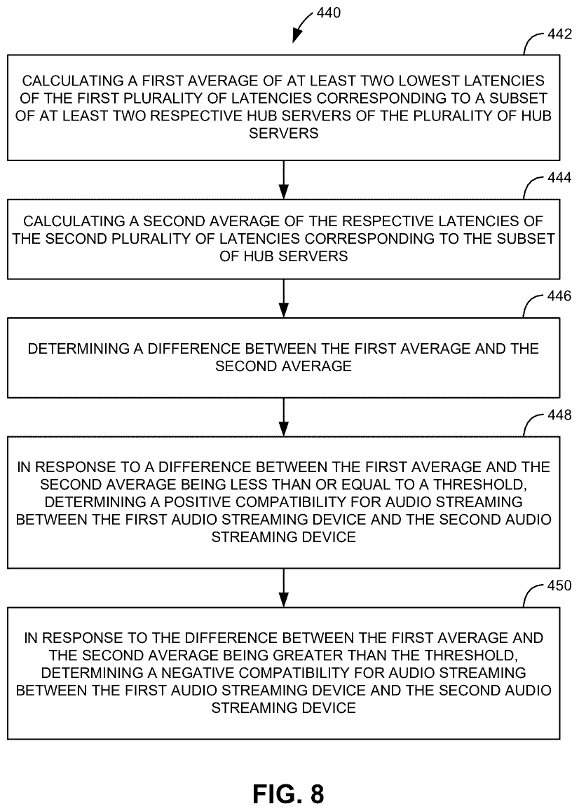

FIG. 8 is a flow diagram illustrating another example method 440 for determining compatibility for audio streaming between a first audio streaming device (e.g., first user) and a second audio streaming device (e.g., second user). In some examples, method 440 may be implemented by further instructions stored in machine-readable storage medium 254a configured to be executed by processor 250 to determine a compatibility for audio streaming between a first audio streaming device and a second audio streaming device as indicated at 280a in FIG. 4A.

As illustrated in FIG. 8 at 442, method 440 includes calculating a first average of at least two lowest latencies of the first plurality of latencies (e.g., latencies between the first audio streaming device and each hub server) corresponding to a subset of at least two respective hub servers of the plurality of hub servers. In some examples, the subset of hub servers may include 2, 3, 4, or more hub servers. At 444, method 440 includes calculating a second average of the respective latencies (e.g., respective latencies between the second audio streaming device and each hub server) of the second plurality of latencies corresponding to the subset of hub servers. At 446, method 440 includes determining a difference between the first average and the second average. At 448, method 440 includes in response to a difference between the first average and the second average being less than or equal to a threshold (e.g., 20 milliseconds, 30 milliseconds), determining a positive compatibility for audio streaming between the first audio streaming device and the second audio streaming device. At 450, method 440 includes in response to the difference between the first average and the second average being greater than the threshold, determining a negative compatibility for audio streaming between the first audio streaming device and the second audio streaming device.

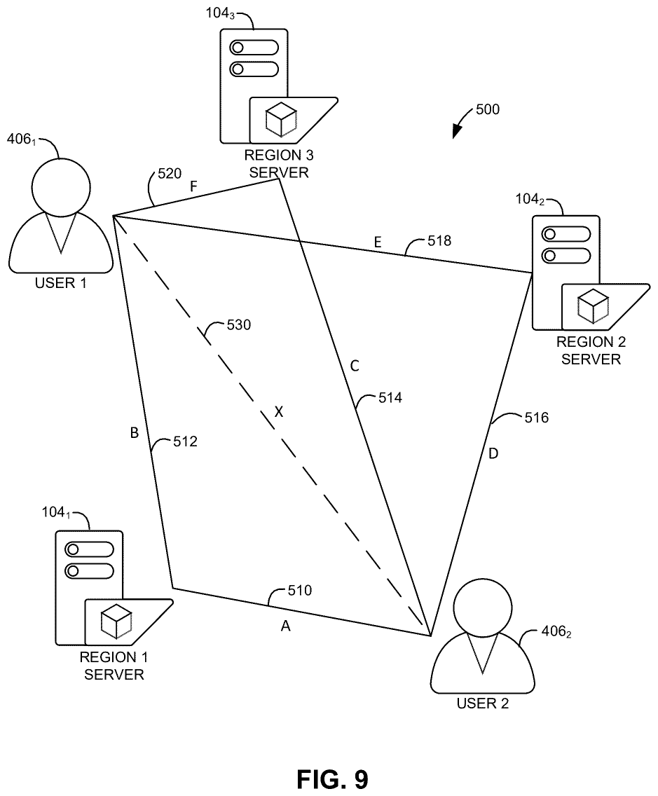

FIG. 9 is a diagram illustrating an example system 500 indicating distances between users 406₁ and 406₂ (e.g., corresponding to an audio streaming device 106₁ and 106₂, respectively) and hub servers 104₁ to 104₃ located in different regions. During the initial power-up sequence of each audio streaming device (e.g., 106₁ to 106_{M}) and for every subsequent power cycle, each audio streaming device may ping each hub server (e.g., 104₁ to 104_{N}) in the list of hub servers (e.g., 204 of FIG. 3) and store the measured latency within the latency table (e.g., 262 of FIG. 5A). The list of hub servers (in different regions) may be stored locally on the audio streaming device (as illustrated by 204 in FIG. 3) and periodically updated via a firmware update function of each audio streaming device. A user may sign up for the musician social networking and collaboration platform that hosts a web application (e.g., via web application server 102 of FIG. 1) that users use to interact with each other and their audio streaming devices. The user may register their audio streaming device to their account on the musician social networking and collaboration platform. When a given user signs in to their account and browses the profile of another user, the web application might calculate a compatibility (e.g., SREF) for audio streaming between the given user and the other user (e.g., as previously described by method 420 of FIG. 7 or 440 of FIG. 8 and/or as further described below).

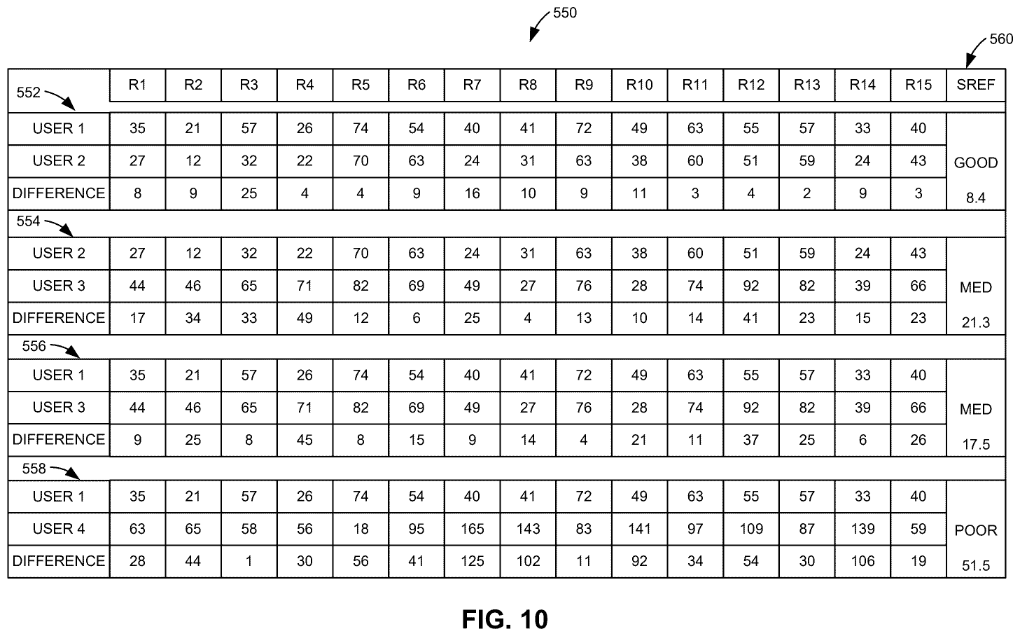

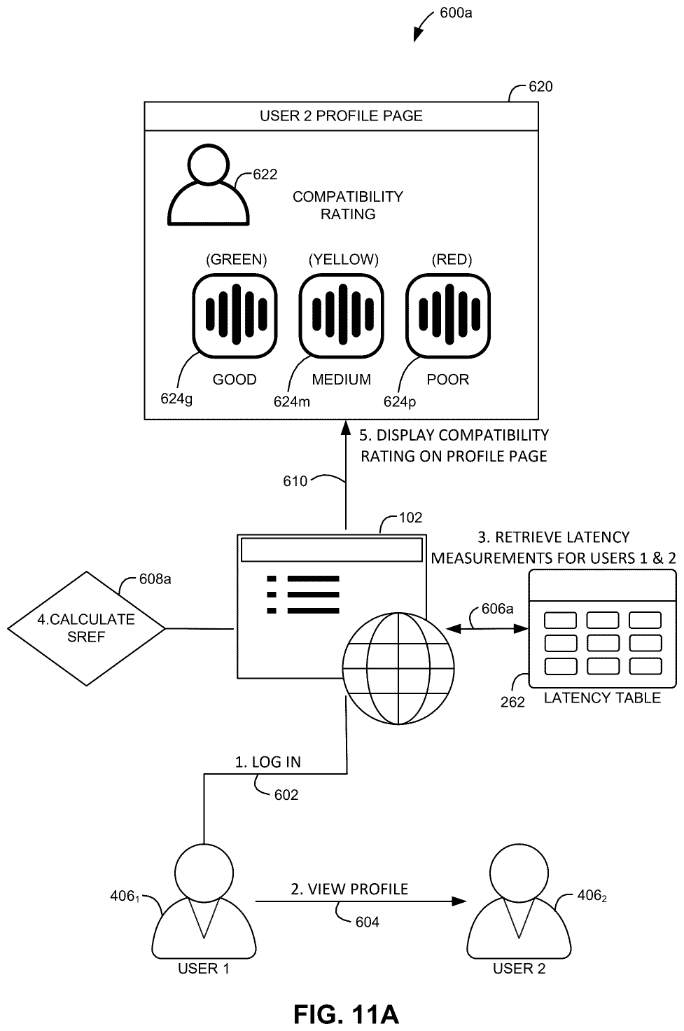

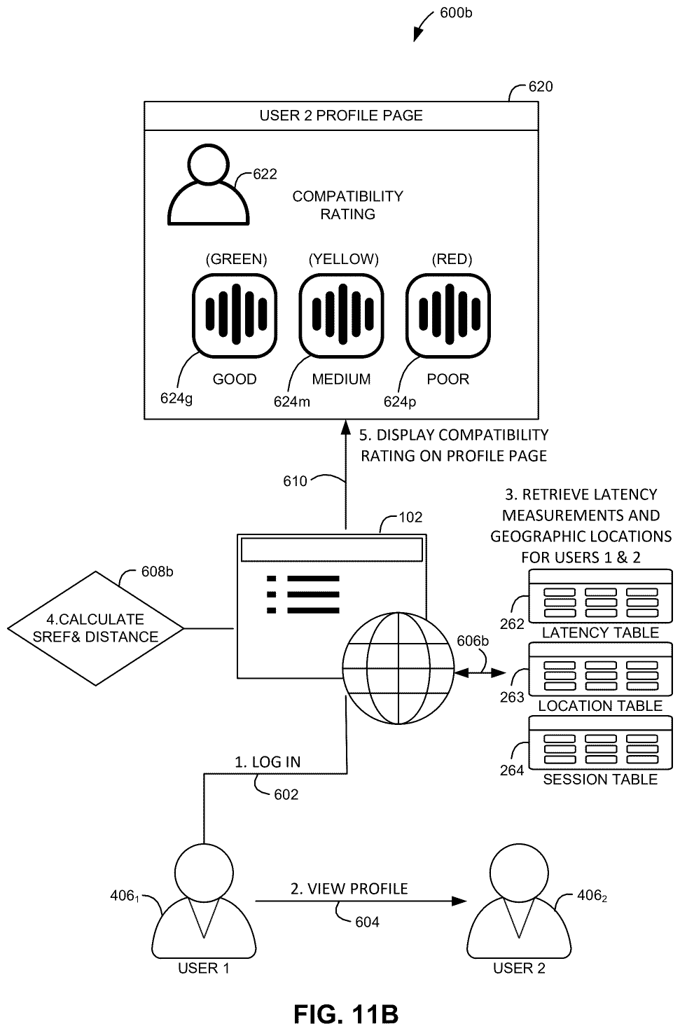

In some examples, the premise of the triangle inequality theorem may be used to provide a reliable estimate of latency between two users despite not knowing the exact latency between the two users. In FIG. 9, the values A as indicated at 510, B as indicated at 512, C as indicated at 514, D as indicated at 516, E as indicated at 518, and F as indicated at 520 are known latencies obtained via the latency measurements and stored in the latency table (e.g., 262 of FIG. 5A). To estimate the value of X as indicated at 530 indicating an estimate of the latency between the first user 406₁ and the second user 406₂, the absolute value of A minus B (for hub server 104₁), C minus F (for hub server 104₃), D minus E (for hub server 104₂), and so on for the remaining regions (e.g., hub servers) is calculated. All these differences are then averaged as indicated in Table 550 of the following FIG. 10. If two audio streaming devices (e.g., users) are in the exact same location, the compatibility calculation would be close to 0 milliseconds, meaning as close to a same-room experience as possible when playing live music. The larger the value of the compatibility calculation, the worse the user experience is expected to be for playing live music. A compatibility rating corresponding to the compatibility calculation may also be determined and displayed to the user as described below with reference to FIG. 11A.

FIG. 10 is a table 550 illustrating example latencies between users and hub servers (in regions R1 to R15) for determining compatibility between users for audio streaming. As indicated at 552, the latency between a first user (USER 1), corresponding to a first audio streaming device 106₁ to 106_{M}, and each hub server in corresponding regions R1 to R15 is known from the measured latencies in the latency table (e.g., 262 of FIG. 5A). For example, the latency between the first user and the hub server in region R1 is 35 milliseconds, the latency between the first user and the hub server in region R2 is 21 milliseconds, the latency between the first user and the hub server in region R3 is 57 milliseconds, etc.

Likewise, the latency between a second user (USER 2), corresponding to a second audio streaming device 106₁ to 106_{M}, and each hub server in corresponding regions R1 to R15 is known from the measured latencies in the latency table (e.g., 262 of FIG. 5A). For example, the latency between the second user and the hub server in region R1 is 27 milliseconds, the latency between the second user and the hub server in region R2 is 12 milliseconds, the latency between the second user and the hub server in region R3 is 32 milliseconds, etc. The difference between the latency for the first user to the hub server in each region R1 to R15 and the latency for the second user to the hub server in each region R1 to R15 is then calculated. For example, the difference in latencies for the hub server in the region R1 is the absolute value of 35 minus 27, which equals 8 milliseconds; the difference in latencies for the hub server in the region R2 is the absolute value of 21 minus 12, which equals 9 milliseconds; the difference in latencies for the hub server in the region R3 is the absolute value of 57 minus 32, which equals 25 milliseconds; etc.

The compatibility (e.g., SREF) as indicated at 560 between the first user and the second user is calculated as the average of all the differences (e.g., 8, 9, 25, etc.), which is calculated to be 8.4 in this example, which might be rated as “GOOD”. As indicated at 554, the compatibility (e.g., SREF) between a second user (USER 2) and a third user (USER 3) is calculated to be 21.3, which might be rated as “MED” (medium). As indicated at 556 the compatibility (e.g., SREF) between the first user (USER 1) and the third user (USER 3) is calculated to be 17.5, which might be rated as “MED”. As indicated at 558, the compatibility (e.g., SREF) between the first user (USER 1) and a fourth user (USER 4) is calculated to be 51.5, which might be rated as “POOR”. In some examples, a compatibility (SREF) less than or equal to a first threshold (e.g., 14 milliseconds) might be rated as “GOOD”, a compatibility (SREF) greater than the first threshold and less than or equal to a second threshold (e.g., 30 milliseconds) might be rated as “MED”, and a compatibility (SREF) greater than the second threshold might be rated as “POOR”.

FIG. 11A is a diagram illustrating an example system 600a for determining a compatibility (e.g., SREF) for audio streaming between a first user 406₁ (e.g., corresponding to a first audio streaming device 106₁) and a second user 406₂ (e.g., corresponding to a second audio streaming device 106₂). The first user 406₁ might log in to the web application server 102 as indicated at 602. The first user 406₁ may then browse the profile of another user (e.g., second user 406₂) as indicated at 604. As indicated at 606a, in response to the first user viewing the profile of the second user, the latency measurements for the first user and the second user are retrieved from the latency table 262. As indicated at 608a, the compatibility (SREF) is calculated based on the retrieved latencies, such as previously described and illustrated with reference to FIGS. 9-10. As indicated at 610, the web application might display a user 2 profile page 620 including the compatibility rating. The profile page 620 may include a photo 622 of the second user and/or other information (e.g., musical preferences, instruments, availability, etc.).

In some examples, a compatibility rating (SREF) of “GOOD” may be indicated by a green image 624g (or other color) and indicate a prediction that the latency between the first and second users will be low such as to be equivalent to playing music in the same room. A compatibility rating of “MED” may be indicated by a yellow image 624m (or other color) and indicate a prediction that the latency between the first and second users may lead to some noticeable delay. The delay, however, may be compensated for by the users. A compatibility rating of “POOR” may be indicated by a red image 624p (or other color) and indicate a prediction that the latency between the first and second users may lead to high amounts of delay which would prevent the users from keeping time/staying in sync while playing music. While images 624g, 624m, and 624p are all shown on profile page 620 in FIG. 11A, in some examples, only one of the images 624g, 624m, or 624p corresponding to the determined compatibility rating may be displayed on the profile page 620.

FIG. 11B is a diagram illustrating another example system 600b for determining a compatibility for audio streaming between a first user 406₁ (e.g., corresponding to a first audio streaming device 106₁) and a second user 406₂ (e.g., corresponding to a second audio streaming device 106₂). The first user 406₁ might log in to the web application server 102 as indicated at 602. The first user 406₁ may then browse the profile of another user (e.g., second user 406₂) as indicated at 604. As indicated at 606b, in response to the first user viewing the profile of the second user, the session table 264 may be checked to determine whether a latency measurement is stored for the first user and the second user. If a latency measurement is stored in the session table 264, the stored latency is used to determine the compatibility rating as previously described. If the latency measurement is not stored in the session table, the latency measurements for the first user and the second user are retrieved from the latency table 262 and the geographic locations of the first user and the second user are retrieved from the location table 263. As indicated at 608b, the compatibility is calculated based on the retrieved latencies and geographic locations, which are used to calculate SREF as previously described and illustrated with reference to FIGS. 9-10 and the distance between the first user and the second user, such as further described and illustrated below with reference to FIG. 18. As indicated at 610, the web application might display a user 2 profile page 620 including the compatibility rating as previously described.

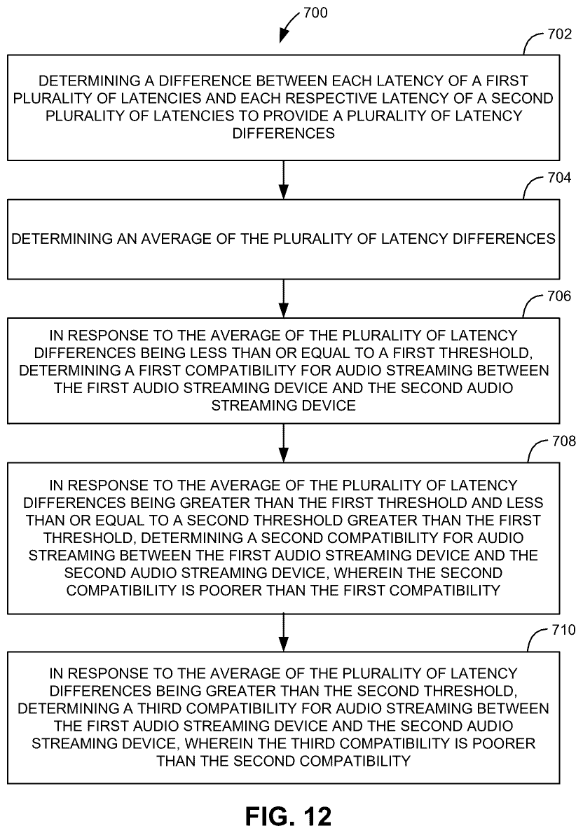

FIG. 12 is a flow diagram illustrating another example method 700 for determining compatibility for audio streaming between a first audio streaming device and a second audio streaming device. In some examples, method 700 may be implemented by further instructions stored in machine-readable storage medium 254a configured to be executed by processor 250 to determine a compatibility for audio streaming between a first audio streaming device and a second audio streaming device as indicated at 280a in FIG. 4A.

As illustrated in FIG. 12 at 702 method 700 includes determining a difference between each latency of a first plurality of latencies (e.g., latencies between a first audio streaming device and each hub server) and each respective latency of a second plurality of latencies (e.g., latencies between a second audio streaming device and each hub server) to provide a plurality of latency differences (e.g., as shown in table 550 of FIG. 10). At 704, method 700 includes determining an average of the plurality of latency differences (e.g., as shown in table 550 of FIG. 10). At 706, method 700 includes in response to the average of the plurality of latency differences being less than or equal to a first threshold (e.g., 14 milliseconds), determining a first compatibility (e.g., “GOOD”) for audio streaming between the first audio streaming device and the second audio streaming device. At 708, method 700 includes in response to the average of the plurality of latency differences being greater than the first threshold and less than or equal to a second threshold (e.g., 30 milliseconds) greater than the first threshold, determining a second compatibility (e.g., “MED”) for audio streaming between the first audio streaming device and the second audio streaming device, wherein the second compatibility is poorer than the first compatibility. At 710, method 700 includes in response to the average of the plurality of latency differences being greater than the second threshold, determining a third compatibility (e.g., “POOR”) for audio streaming between the first audio streaming device and the second audio streaming device, wherein the third compatibility is poorer than the second compatibility.

FIGS. 13A-13C are flow diagrams illustrating an example method 800 for selecting a hub server (e.g., 104₁ to 104_{N}) to host an audio streaming session. In some examples, method 800 may be implemented by further instructions stored in machine-readable storage medium 254a configured to be executed by processor 250 to select a hub server to host an audio streaming session based on the latency table (e.g., 262) as indicated at 292a in FIG. 4A.

As illustrated in FIG. 13A at 802, method 800 includes determining the hub server (e.g., 104₁ to 104_{N}) with the lowest latency for each of the at least two selected audio streaming devices (e.g., based on latency table 262). At 804, method 800 includes in response to a hub server corresponding to a first majority of the determined hub servers with the lowest latency, selecting the hub server corresponding to the first majority to host the audio streaming session.

As illustrated in FIG. 13B at 806, method 800 may further include in response to no hub server corresponding to the first majority of the determined hub servers with the lowest latency, determining the hub server with the second lowest latency for each of the at least two selected audio streaming devices. At 808, method 800 may further include in response to a hub server corresponding to a second majority of the determined hub servers with the second lowest latency, selecting the hub server corresponding to the second majority to host the audio streaming session.

As illustrated in FIG. 13C at 810, method 800 may further include in response to no hub server corresponding to the second majority of the determined hub servers with the second lowest latency, determining the hub server with the third lowest latency for each of the at least two selected audio streaming devices. At 812, method 800 may further include in response to a hub server corresponding to a third majority of the determined hub servers with the third lowest latency, selecting the hub server corresponding to the third majority to host the audio streaming session. In some examples, in response to no hub server corresponding to the third majority of the determined hub servers with the third lowest latency, the process may be repeated to determine the hub server with the fourth lowest latency for each of the at least two selected audio streaming devices and so on until a suitable hub server is determined.

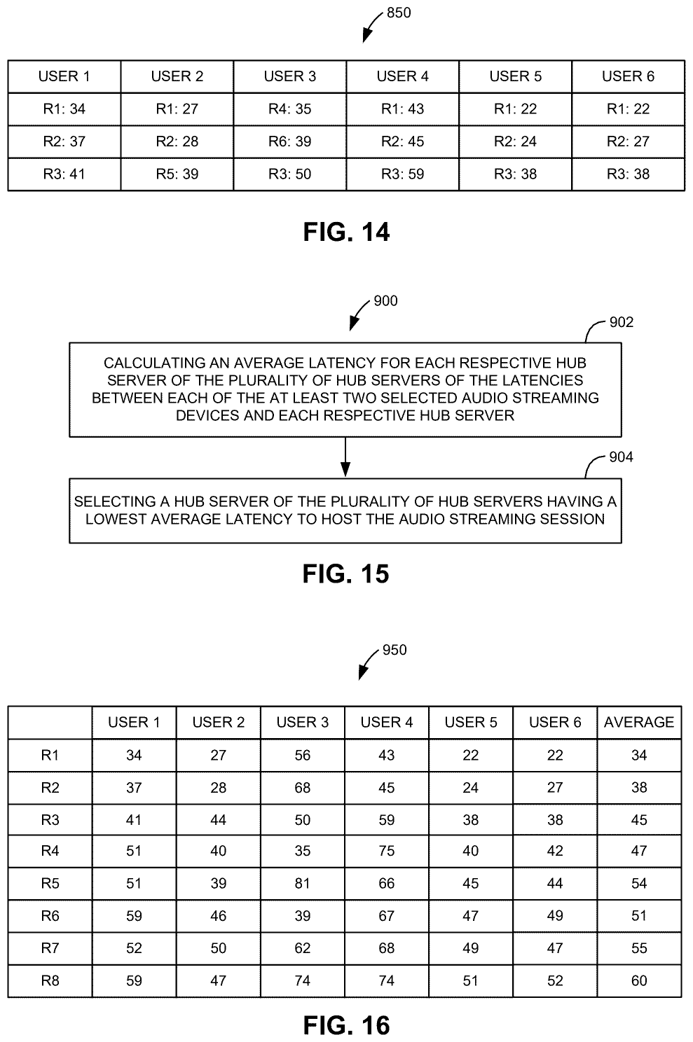

FIG. 14 is a table 850 illustrating example latencies between users and hub servers (e.g., 104₁ to 104_{N}) for selecting a hub server to host an audio streaming session according to method 800 of FIGS. 13A-13C. Table 850 includes users 1 to 6 (e.g., each corresponding to an audio streaming device 106₁ to 106_{M}) for an audio streaming session and hub servers corresponding to regions R1 to R6. For each user, the hub servers having the three lowest latencies are listed. For example, for user 1, the hub server having the lowest latency corresponds to region R1 (e.g., 34 milliseconds), the hub server having the second lowest latency corresponds to region R2 (e.g., 37 milliseconds), and the hub server having the third lowest latency corresponds to region R3 (e.g., 41 milliseconds). In this example, users 1, 2, 4, 5, and 6 have the lowest latency to the hub server corresponding to region R1, while user 3 has the lowest latency to the hub server corresponding to region R4. Thus, since the hub server corresponding to region R1 is the majority of the determined hub servers with the lowest latency, the hub server corresponding to region R1 is selected to host the audio streaming session between users 1 to 6.

FIG. 15 is a flow diagram illustrating another example method 900 for selecting a hub server (e.g., 104₁ to 104_{N}) to host an audio streaming session. In some examples, method 900 may be implemented by further instructions stored in machine-readable storage medium 254a configured to be executed by processor 250 to select a hub server to host an audio streaming session based on the latency table (e.g., 262) as indicated at 292a in FIG. 4A.

As illustrated in FIG. 15 at 902, method 900 includes calculating an average latency for each respective hub server of the plurality of hub servers (e.g., 104₁ to 104_{N}) of the latencies between each of the at least two selected audio streaming devices and each respective hub server. At 904, method 900 includes selecting a hub server of the plurality of hub servers having a lowest average latency to host the audio streaming session.

FIG. 16 is a table 950 illustrating example latencies between users and hub servers (e.g., 104₁ to 104_{N}) for selecting a hub server to host an audio streaming session according to method 900 of FIG. 15. Table 950 includes users 1 to 6 (e.g., each corresponding to an audio streaming device 106₁ to 106_{M}) for an audio streaming session and hub servers corresponding to regions R1 to R8. For each user, the latency to each hub server is listed (e.g., based on the latency table 262 of FIG. 5A). For example, for user 1, the latency to the hub server corresponding to region R1 is 34 milliseconds, the latency to the hub server corresponding to region R2 is 37 milliseconds, the latency to the hub server corresponding to region R3 is 41 milliseconds, etc. The average of the latencies for each hub server corresponding to regions R1 to R8 for the selected users 1 to 6 is calculated to determine the hub server having the lowest average latency. For example, for the hub server corresponding to region R1, the user 1 latency is 34 milliseconds, the user 2 latency is 27 milliseconds, the user 3 latency is 56 milliseconds, the user 4 latency is 43 milliseconds, the user 5 latency is 22 milliseconds, and the user 6 latency is 22 milliseconds, such that the average is 34 milliseconds. The average latency for the hub server corresponding to region R2 is 38 milliseconds, the average latency for the hub server corresponding to region R3 is 45 milliseconds, the average latency for the hub server correspond to region R4 is 47 milliseconds, etc. Accordingly, since the hub server corresponding to region R1 has the lowest average latency (e.g., 34 milliseconds), the hub server corresponding to region R1 is selected to host the audio streaming session.

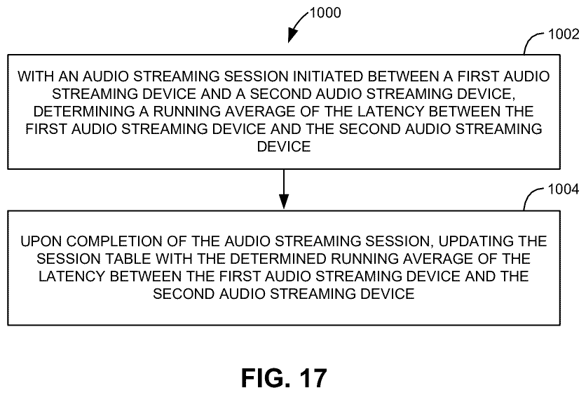

FIG. 17 is a flow diagram illustrating an example method 1000 for updating a session table (e.g., 264 of FIG. 5C). In some examples, method 1000 may be implemented by further instructions stored in machine-readable storage medium 254b configured to be executed by processor 250 to update session table 264 as indicated at 275 in FIG. 4B.

As illustrated in FIG. 17 at 1002, method 1000 includes with an audio streaming session initiated between a first audio streaming device (e.g., first user) and a second audio streaming device (e.g., second user), determining a running average of the latency between the first audio streaming device and the second audio streaming device. At 1004, method 1000 includes upon completion of the audio streaming session, updating the session table (e.g., 264 of FIG. 5C) with the determined running average of the latency between the first audio streaming device and the second audio streaming device. For example, for ID field 320 equal to “1” in session table 264, the device ID (“DEVICE 1 ID”) of the first audio streaming device may be stored in the first device field 322, the device ID (“DEVICE 2 ID”) of the second audio streaming device may be stored in the second device field 324, the running average of the latency (“LATENCY 1”) between the first audio streaming device and the second audio streaming device may be stored in the latency field 328, and the day and time the latency field 328 was updated (“TIMESTAMP 1”) may be stored in the time stamp field 326.

FIG. 18 is a flow diagram illustrating another example method 1100 for determining compatibility for audio streaming between a first audio streaming device (e.g., first user) and a second audio streaming device (e.g., second user). In some examples, method 1100 may be implemented by further instructions stored in machine-readable storage medium 254b configured to be executed by processor 250 to determine a compatibility for audio streaming between a first audio streaming device and a second audio streaming device as indicated at 280b in FIG. 4B.

As illustrated in FIG. 18 at 1102, method 1100 includes obtaining the latency measurements to each hub server for a first audio streaming device and a second audio streaming device (e.g., by reading the latency measurements from latency table 262 of FIG. 5A). At 1104, method 1100 includes obtaining the geographic locations for the first audio streaming device and the second audio streaming device (e.g., by reading the location data from location table 263 of FIG. 5B). At 1106, method 1100 may include filtering outliers from the latency measurements to each hub server for the first audio streaming device and the second audio streaming device. In some examples, filtering the outliers includes using the interquartile range (IQR) method to prevent one hub server from skewing the results.

At 1108, method 1100 includes calculating a SREF component based on the filtered latency measurements. The SREF component may be calculated as previously described and illustrated with reference to FIGS. 7-12. At 1110, method 1100 includes calculating a distance component between the first audio streaming device and the second audio streaming device based on the geographic locations for the first audio streaming device and the second audio streaming device. In some examples, the distance component is calculated as the straight-line distance between the first audio streaming device and the second audio streaming device using the haversine formula (e.g., great-circle distance based on the latitude and longitude of the first audio streaming device and the latitude and longitude of the second audio streaming device).

At 1112, method 1100 includes predicting latency between the first audio streaming device and the second audio streaming device based on the SREF component and the distance component. In some examples, the latency prediction is based on three components including a base latency or adjusted baseline (e.g., adjusted base latency), a network asymmetry calculated using the SREF component, and a geographic component calculated using the distance component. Each of the three components may be assigned a different weight. In some examples, the network asymmetry may be assigned a first weight (W1), such as within a range between 60% and 90% (e.g., 80%), the geographic component may be assigned a second weight (W2), such as within a range between 10% and 40% (e.g., 20%) less than the first weight (W1), and the base latency or adjusted baseline may be assigned a third weight (W3), such as within a range between 80% and 95% (e.g., 90%). Accordingly, in some examples, where the base latency is used, the predicted latency may be defined as follows:

$$predicted\_latency = ( base\_latency \times W 3 ) + ( network\_asymmetry \times W 1 ) + ( geographic\_component \times W 2 )$$

In examples where the adjusted baseline is used, the predicted latency may be defined as follows:

$$predicted\_latency = ( adjusted\_baseline \times W 3 ) + ( network\_asymmetry \times W 1 ) + ( geographic\_component \times W 2 )$$

In some examples, the adjusted baseline may be calculated by first determining an asymmetry factor as follows:

$$asymmetry\_factor = min ( SREF\_component / 10 , 1. )$$

and then by calculating the adjusted baseline based on the base latency and the asymmetry factor as follows:

$$adjusted\_baseline = base\_latency \times ( 0.5 + 0.5 \times asymmetry\_factor )$$

The network asymmetry may be calculated using the SREF component as follow:

$$network\_asymmetry = ( SREF\_component \hat{} C 1 ) + ( SREF\_component \times C 2 )$$

where:

C1 is a diminishing returns scaling factor (e.g., within a range between 0.70 and 0.90, such as 0.81); and
C2 is a linear factor for a fine-tuning adjustment for proportional impact (e.g., within a range between 0.85 and 0.99, such as 0.94).

The geographic component may be calculated using the distance component as follows:

$$geographic\_component = distance\_component \times C 3 \times C 4$$

where:
C3 is the milliseconds per mile for a data packet round-trip over the network (e.g., 60 ms round-trip divided by 500 miles equals 0.12); and
C4 is a reduction factor for network routing overhead, since network paths are not straight lines (e.g., within a range between 0.1 and 0.4, such as 0.3).

The base latency is the minimum realistic latency under ideal network conditions. In some examples, the base latency may be derived using the Nelder-Mead method. The base latency may be within a range between 20 milliseconds and 40 milliseconds (e.g., 29.4 milliseconds). In some examples, the base latency or adjusted baseline may be weighted at 90% (e.g., W3=0.9) to prevent over-prediction, the network asymmetry, which is the primary predictive factor, may be weighted at 80% (e.g., W1=0.8), and the geographic component, which provides validation, may be weighted at 20% (e.g., W2=0.2). At 1114, method 1100 includes determining a compatibility for audio streaming latency (e.g., as previously described with reference to FIGS. 11A and 11B) between the first audio streaming device and the second audio streaming device based on the predicted latency.

The systems, devices, and methods disclosed herein enable musicians to collaborate in real time over a network and keep time with each other while playing live music. By determining compatibility between users and by selecting an appropriate hub server to host the audio streaming session between users, the latency between the users may be minimized to improve the quality of the audio streaming session.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a web application server;
a plurality of hub servers; and
a first audio streaming device configured to:
ping each hub server of the plurality of hub servers to determine a respective latency between the first audio streaming device and each hub server to provide a first plurality of latencies; and
transmit the first plurality of latencies to the web application server;
wherein the web application server is configured to:
store the first plurality of latencies in a latency table comprising a respective second plurality of latencies for a second audio streaming device; and
determine a compatibility for audio streaming between the first audio streaming device and the second audio streaming device based on the latency table.

2. The system of claim 1, wherein to determine the compatibility for audio streaming between the first audio streaming device and the second audio streaming device, the web application server is configured to:
determine a difference between each latency of the first plurality of latencies and each respective latency of the second plurality of latencies to provide a plurality of latency differences;
in response to a smallest latency difference of the plurality of latency differences being less than or equal to a threshold, determining a positive compatibility for audio streaming between the first audio streaming device and the second audio streaming device; and
in response to the smallest latency difference of the plurality of latency differences being greater than the threshold, determining a negative compatibility for audio streaming between the first audio streaming device and the second audio streaming device.

3. The system of claim 1, wherein to determine the compatibility for audio streaming between the first audio streaming device and the second audio streaming device, the web application server is configured to:
determine a difference between each latency of the first plurality of latencies and each respective latency of the second plurality of latencies to provide a plurality of latency differences;
determine an average of the plurality of latency differences;
in response to the average of the plurality of latency differences being less than or equal to a first threshold, determining a first compatibility for audio streaming between the first audio streaming device and the second audio streaming device;
in response to the average of the plurality of latency differences being greater than the first threshold and less than or equal to a second threshold greater than the first threshold, determining a second compatibility for audio streaming between the first audio streaming device and the second audio streaming device, wherein the second compatibility is poorer than the first compatibility; and
in response to the average of the plurality of latency differences being greater than the second threshold, determining a third compatibility for audio streaming between the first audio streaming device and the second audio streaming device, wherein the third compatibility is poorer than the second compatibility.

4. The system of claim 1, wherein to determine the compatibility for audio streaming between the first audio streaming device and the second audio streaming device, the web application server is configured to:
calculate a first average of at least two lowest latencies of the first plurality of latencies corresponding to a subset of at least two respective hub servers of the plurality of hub servers;
calculate a second average of the respective latencies of the second plurality of latencies corresponding to the subset of hub servers;
determine a difference between the first average and the second average;
in response to a difference between the first average and the second average being less than or equal to a threshold, determining a positive compatibility for audio streaming between the first audio streaming device and the second audio streaming device; and
in response to the difference between the first average and the second average being greater than the threshold, determining a negative compatibility for audio streaming between the first audio streaming device and the second audio streaming device.

5. The system of claim 4, wherein the subset of hub servers comprises three hub servers.

6. The system of claim 1, wherein the first audio streaming device comprises:
a first analog audio input port;
an audio output port;
a network interface;
a memory storing instructions; and
a processor communicatively coupled to the analog audio input port, the audio output port, the network interface, and the memory, the processor configured to execute the instructions to:
ping each hub server of the plurality of hub servers to determine the respective latency between the first audio streaming device and each hub server to provide the first plurality of latencies; and
transmit the first plurality of latencies to the web application server.

7. The system of claim 6, wherein the first audio streaming device further comprises:
a second analog input port communicatively coupled to the processor; and
a microphone communicatively coupled to the processor.

8. The system of claim 1, wherein each of the plurality of hub servers is located at a different geographic location.

9. A system comprising:
a plurality of audio streaming devices;
a plurality of hub servers communicatively coupled to the plurality of audio streaming devices; and
a web application server storing a latency table comprising a latency between each audio streaming device of the plurality of audio streaming devices and each hub server of the plurality of hub servers, the web application server configured to:
receive a request to initiate an audio streaming session between at least two selected audio streaming devices of the plurality of audio streaming devices; and
select a hub server of the plurality of hub servers to host the audio streaming session based on the latency table.

10. The system of claim 9, wherein to select the hub server to host the audio streaming session, the web application server is configured to:
determine the hub server with the lowest latency for each of the at least two selected audio streaming devices; and
in response to a hub server corresponding to a first majority of the determined hub servers with the lowest latency, select the hub server corresponding to the first majority to host the audio streaming session.

11. The system of claim 10, wherein in response to no hub server corresponding to the first majority of the determined hub servers with the lowest latency, the web application server is configured to:
determine the hub server with the second lowest latency for each of the at least two selected audio streaming devices; and
in response to a hub server corresponding to a second majority of the determined hub servers with the second lowest latency, select the hub server corresponding to the second majority to host the audio streaming session.

12. The system of claim 11, wherein in response to no hub server corresponding to the second majority of the determined hub servers with the second lowest latency, the web application server is configured to:
determine the hub server with the third lowest latency for each of the at least two selected audio streaming devices; and
in response to a hub server corresponding to a third majority of the determined hub servers with the third lowest latency, select the hub server corresponding to the third majority to host the audio streaming session.

13. The system of claim 9, wherein to select the hub server to host the audio streaming session, the web application server is configured to:
calculate an average latency for each respective hub server of the plurality of hub servers of the latencies between each of the at least two selected audio streaming devices and each respective hub server; and
select a hub server of the plurality of hub servers having a lowest average latency to host the audio streaming session.

14. An audio streaming device comprising:
a first analog audio input port;
an audio output port;
a network interface;
a memory storing instructions; and
a processor communicatively coupled to the analog audio input port, the audio output port, the network interface, and the memory, the processor configured to execute the instructions to:
ping each hub server of a plurality of hub servers to determine a respective latency between the audio streaming device and each hub server to provide a plurality of latencies; and
transmit the plurality of latencies to a web application server.

15. The audio streaming device of claim 14, wherein the processor is configured to execute the instructions to:
ping a further audio streaming device to determine a peer-to-peer latency between the audio streaming device and the further audio streaming device;
in response to the peer-to-peer latency being less than or equal to a threshold, determining a positive compatibility for audio streaming between the audio streaming device and the further audio streaming device; and
in response to the peer-to-peer latency being greater than the threshold, determining a negative compatibility for audio streaming between the audio streaming device and the further audio streaming device.

16. A method comprising:
receiving, at a web application server, from each audio streaming device of a plurality of audio streaming devices, a latency between each audio streaming device and each hub server of a plurality of hub servers;
storing, via the web application server, a latency table comprising the latency between each audio streaming device and each hub server; and
determining, via the web application server, a compatibility for audio streaming between a first audio streaming device and a second audio streaming device of the plurality of audio streaming devices based on the latency table.

17. The method of claim 16, further comprising:
receiving, at the web application server, a request to schedule an audio streaming session between at least two selected audio streaming devices of the plurality of streaming devices; and
selecting, via the web application server, a hub server of the plurality of hub servers to host the audio streaming session based on the latency table.

18. The method of claim 17, wherein selecting the hub server of the plurality of hub servers to host the audio streaming session comprises:
determining the hub server with the lowest latency for each of the at least two selected audio streaming devices; and
in response to a hub server corresponding to a first majority of the determined hub servers with the lowest latency, selecting the hub server corresponding to the first majority to host the audio streaming session.

19. The method of claim 18, wherein in response to no hub server corresponding to the first majority of the determined hub servers with the lowest latency, determining the hub server with the second lowest latency for each of the at least two selected audio streaming devices; and
in response to a hub server corresponding to a second majority of the determined hub servers with the second lowest latency, selecting the hub server corresponding to the second majority to host the audio streaming session.

20. The method of claim 19, wherein in response to no hub server corresponding to the second majority of the determined hub servers with the second lowest latency, determining the hub server with the third lowest latency for each of the at least two selected audio streaming devices; and
in response to a hub server corresponding to a third majority of the determined hub servers with the third lowest latency, selecting the hub server corresponding to the third majority to host the audio streaming session.

21. The method of claim 17, wherein selecting the hub server of the plurality of hub servers to host the audio streaming session comprises:
calculating an average latency for each respective hub server of the plurality of hub servers of the latencies between each of the at least two selected audio streaming devices and each respective hub server; and
selecting a hub server of the plurality of hub servers having a lowest average latency to host the audio streaming session.
